(19) United States
(12) Patent Application Publication
(10) Pub. No.: US 2025/0121663 A1
(43) Pub. Date: Apr. 17, 2025

(54) ELECTRIC TRANSAXLE

(71) Applicant: Hydro-Gear Limited Partnership, Sullivan, IL (US)

(72) Inventors: Nathan W. Bonny, Shelbyville, IL (US); Scott E. Windhorst, Sullivan, IL (US); Henry J. Hansen, Zionsville, IN (US); Shane A. Deters, Charleston, IL (US); Michael L. Bennett, Sullivan, IL (US)

(21) Appl. No.: 18/913,933

(22) Filed: Oct. 11, 2024

Related U.S. Application Data
(60) Provisional application No. 63/621,392, filed on Jan. 16, 2024.
(60) Provisional application No. 63/589,866, filed on Oct. 12, 2023.

(51) Int. Cl. B60K 1/00; B60K 17/16

(52) U.S. Cl. CPC B60K 1/00; B60K 17/16; B60K 2001/001

(57) ABSTRACT

An electric transaxle includes a main housing defining threaded holes. The transaxle includes a first axle horn connected to the main housing. The transaxle includes an electric motor assembly that includes an electrical connector and the electric motor assembly is attached to the main housing next to the first axle horn to form a compact arrangement. The electric motor assembly defines through-holes. The electric motor assembly includes fasteners, each of which extends through a respective one of the through-holes and engages a respective one of the threaded holes, to attach the electric motor assembly to the main housing. The through-holes and the threaded holes are arranged in a first regular polygon shape to enable attachment of the electric motor assembly to the main housing in multiple orientations to orient the electrical connector away from the first axle horn in various installed orientations of the transaxle.

### CROSS-REFERENCE TO RELATED APPLICATIONS

This application claims the benefit of U.S. Provisional Patent Application No. 63/621,392, filed on Jan. 16, 2024, and U.S. Provisional Patent Application No. 63/589,866, filed on Oct. 12, 2023, both of which are incorporated herein by reference in their entirety.

### TECHNICAL FIELD

This application relates to an electric transaxle incorporating an electric motor, reduction gearing, and differential output. An electric transaxle in accordance with this disclosure may be used in applications such as a ground drive for a lawn mower, other utility vehicle or the like, and other applications.

### BACKGROUND

Many vehicles, such as lawn mowers and other utility vehicles, include transaxles. In some configurations, a transaxle may combine a motor, reduction gearing, a differential, and drive (or “output”) axles. Because a transaxle combines various substantial components in a single unit, it may be difficult to effectively minimize the footprint of a transaxle as installed on a vehicle. Additionally, a transaxle may be installed in a particular position and orientation in a vehicle based on the arrangement of other components of the vehicle. Different vehicle models may require the transaxle to be in different respective positions and installed orientations, thereby making it difficult to use the same transaxle design for different vehicle models.

### SUMMARY

Electrically-powered transaxles are disclosed herein. These designs provide a relatively compact envelope for use with an electric or hybrid drive lawn mower or other utility vehicle. These fully-sealed electric drives can be oriented as needed to protect power and control conductors.

A disclosed example of an electric transaxle includes a main housing and a side housing, each having an integrally-formed axle horn portion. The electric transaxle also includes an electric motor assembly attached to the main housing by means of fasteners equidistantly spaced on a bolt circle to form a regular polygon such that the electric motor assembly can be rotationally oriented in at least three different orientations with respect to the main housing about the rotational axis of the electric motor output shaft.

Another disclosed example of an electric transaxle includes a two-piece main housing assembly comprising a main housing and an attached or “bolt-on” axle horn in lieu of an integrally-formed axle horn portion of the main housing. In this example, a volume of oil is not present in the “bolt-on” axle horn. An axle extends through a seal in the main housing, the empty interior (or volume of air) of the attached axle horn, and a sealed bearing. In some examples, the axle also extends through an environmental seal that may be installed adjacent to the sealed bearing for additional environmental protection.

The bolt-on axle horn of this electric transaxle may include multiple tapered lobes formed equidistantly apart from one another. For example, an example electric transaxle includes four tapered lobes formed at right angles to one another, providing an exceptional strength-to-weight ratio and allowing a smaller spatial envelope for this axle horn. Due to its flowing, curvilinear design, this lobed axle horn does not trap as much dirt and/or other debris on its exterior surfaces as other axle horns and therefore accumulates less weight during operation in dirty environments and is easier to clean. Also, the reduction gear chamber is sealed off from the axle horn volume (of air), so oil is not present in the axle horn, thereby further reducing the volume, weight and cost of the oil present in the assembled drive unit. Accordingly, this electric transaxle provides a relatively eco-friendly solution since oil volume is reduced and oil leaks that typically can occur through worn axle seals are reduced. Due to its smaller spatial envelope, this bolt-on axle horn configuration enables simplified machining of each of the two primary components of the main housing assembly (namely the main housing and the bolt-on axle horn) and supports vehicle applications requiring longer axles due to its machinability and high-strength design. The bolt-on axle horn also allows adjustment of axle bearing locations, via interchangeable bolt-on axle horns, for improved axle support. It should be noted that the bolt-on axle horn may contain a volume of oil in some vehicle applications.

A better understanding of the invention will be obtained from the following detailed descriptions and accompanying drawings, which set forth illustrative examples that are indicative of the various ways in which the principals of the invention may be employed.

### BRIEF DESCRIPTION OF THE DRAWINGS

FIG. 1 is an external perspective view of an example electric transaxle in accordance with the disclosure herein.

FIG. 2 is a partially exploded view of the electric transaxle of FIG. 1, with the stator housing, motor windings and certain fasteners removed for clarity.

FIG. 3 is another partially exploded view of the electric transaxle of FIG. 1, with the stator housing, motor windings and certain fasteners removed for clarity.

FIG. 4 is an external perspective view of another electric transaxle comprising a bolt-on axle horn in accordance with the disclosure herein.

FIG. 5 is an external perspective view of the electric transaxle of FIG. 4, with the bolt-on axle horn removed.

FIG. 6 is an internal elevation view of the bolt-on axle horn of FIG. 4.

### DETAILED DESCRIPTION OF THE DRAWINGS

The description that follows describes, illustrates and exemplifies one or more embodiments of the invention in accordance with its principles. This description is not provided to limit the invention to the embodiment(s) described herein, but rather to explain and teach the principles of the invention in order to enable one of ordinary skill in the art to understand these principles and, with that understanding, be able to apply them to practice not only the embodiment(s) described herein, but also any other embodiment that may come to mind in accordance with these principles. The scope of the invention is intended to cover all such embodiments that may fall within the scope of the appended claims, either literally or under the doctrine of equivalents.

It should be noted that the drawings set forth herein are not necessarily drawn to scale and, in some instances, proportions may have been exaggerated to depict certain features more clearly. As stated above, this specification is intended to be taken as a whole and interpreted in accordance with the principles of the invention(s) as taught herein and understood by one of ordinary skill in the art.

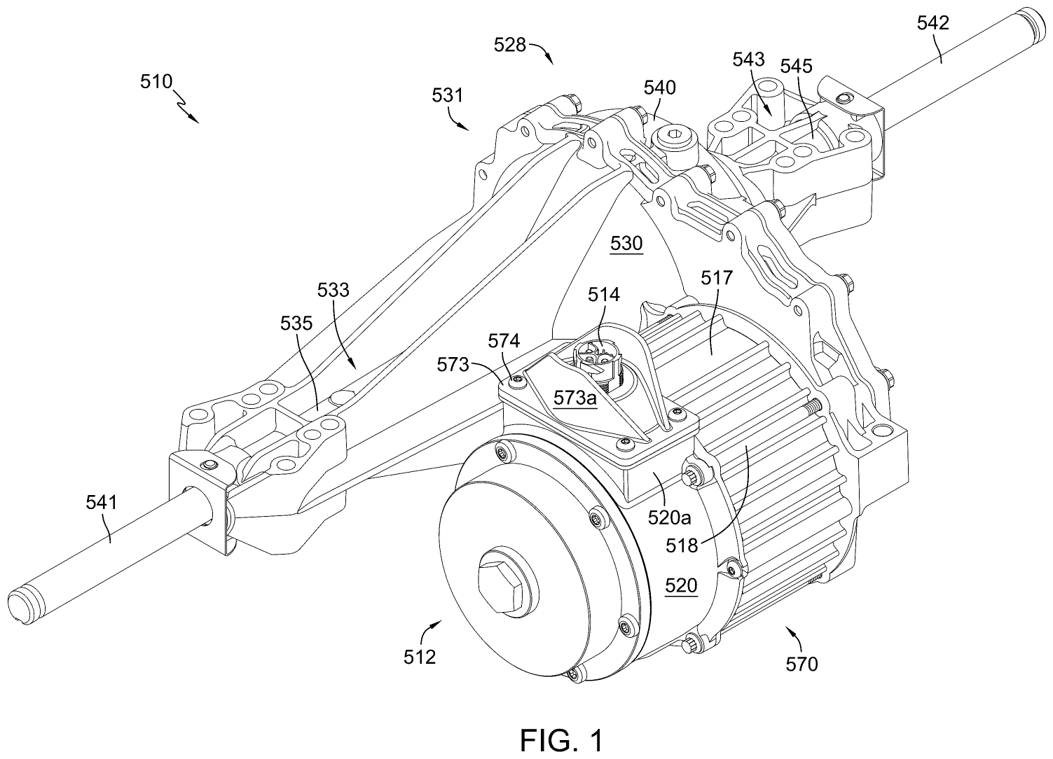

As depicted in FIGS. 1-3, an example electric transaxle 510 includes an electric brake assembly 512. In some examples, electric brake assembly 512 is spring biased. Electric transaxle 510 also includes a transaxle housing assembly 528 that includes a main housing 530 and a side housing 540. A motor end cap 520 and side housing 540 are attached to opposite sides of main housing 530. Motor end cap 520 is attached to main housing 530 by means of fasteners 518 (also referred to as “first plurality of fasteners” and “motor fasteners”), with a motor stator housing 517 interposed between main housing 530 and motor end cap 520 to form an electric motor compartment containing an electric motor 521 of an electric motor assembly 570.

Electric motor assembly 570 includes an electrical connector 514, an electrical compartment cover 573, and an electrical compartment 520a. Electrical connector 514 is mounted/attached to electrical compartment cover 573, which is secured by fasteners 574 to electrical compartment 520a. Electrical compartment 520a extends from motor end cap 520 of electric motor assembly 570. Electrical connector 514, which is environmentally sealed, may include motor power phase terminals, brake coil terminals and motor control terminals, and may be configured for connection to a vehicle control system, such as by a flexible electrical cable. It Electrical connector 514 may comprise a CAN bus connector for power and communication inputs provided via three-phase power through the flexible electrical cable. Electrical compartment cover 573 includes connector guards 573a that extend beyond electrical connector 514 to protect electrical connector 514.

Electric transaxle 510 is configured to be positioned in various installed orientations (e.g., orientation as installed in a vehicle, etc.) about axis of rotation 505 of axles 541, 542 (also referred to as “axle axis of rotation” and “second axis of rotation”). Axles 541, 542 are collinear such that both axles 541, 542 extend along axis of rotation 505. This allows positioning and orientation of electric transaxle 510 in a vehicle such that power and control/communication conductors that are routed and connected to electric transaxle 510 may be better protected (among other considerations, such as fitting within an allotted spatial envelope within the vehicle).

Additionally, in the illustrated example, motor end cap 520 is mounted/attached to main housing 530 via through-holes 520b defined by motor end cap 520, bolt holes 530b defined by main housing 530, and fasteners 518 (e.g., threaded fasteners). Bolt holes 530b (also referred to as “threaded holes” and “first plurality of threaded holes”) are located equidistantly from each other and arranged on a bolt circle 530a (also referred to as “first bolt circle”) about axis of rotation 504 to form a regular polygon. Similarly, through-holes 520b (also referred to as “first plurality of through-holes”) are equidistantly spaced apart and arranged about axis of rotation 504 to form the same regular polygon. These two regular polygons are both centered about axis of rotation 504. Each fastener 518 extends through a respective through-hole 520b and engages a respective bolt hole 530b to attach electric motor assembly 570 to main housing 530. Through-holes 520b and bolt holes 530b are arranged such that motor end cap 520 (and electrical connector 514) can be rotationally oriented about an axis of rotation 504 of a motor output shaft 525 to enable mounting of electric motor assembly 570 in different orientations to position electrical connector 514 away from axle horn 535 and in an accessible location. In the illustrated example, electric motor assembly 570 is attached to main housing 530 next to axle horn 535 to form a compact arrangement.

In the illustrated example, main housing 530 defines four bolt holes 530b located on bolt circle 530a and motor end cap 520 defines four through-holes 520b. In turn, electric motor assembly 570 is mountable to main housing 530 in four different orientations, three of which position electrical connector 514 away from first axle horn 535 to provide easy access to electrical connector 514. That is, electric motor assembly 570 is configured to be attached to main housing 530 in multiple rotational orientations to position electrical connector 514 away from axle horn 535 in various orientations in which electric transaxle 510 may be installed in a vehicle. In other examples, a different number of fasteners 518 and bolt holes 530b are present (e.g., five or six) to allow a different number of orientations (e.g., five or six) of motor end cap 520. In some examples, bolt holes 530b are positioned on bolt circle 530a about axis of rotation 504 (also referred to as “motor axis of rotation” and “first axis of rotation”) such that any position in the 360 degrees of bolt circle 530a located on main housing 530 is attainable. It should be noted that some orientations of motor end cap 520 may require an angled mating connector to engage with electrical connector 514 to provide clearance with proximate structure of main housing 530. In the illustrated example, use of an angled mating connector may enable mounting of motor end cap 520 in four orientations using fasteners 518.

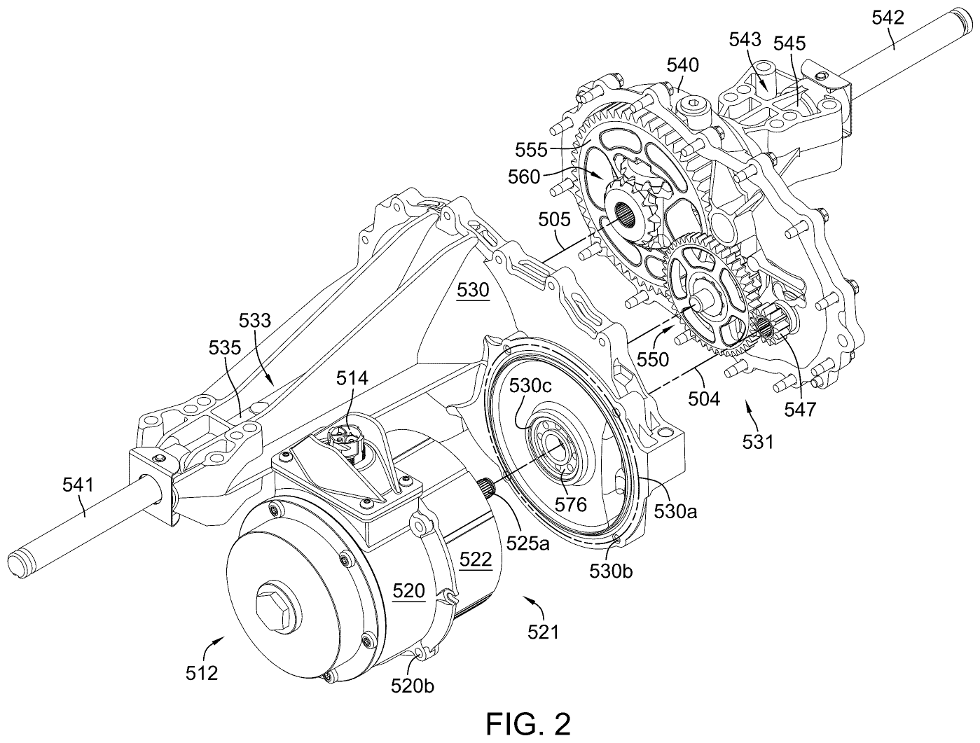

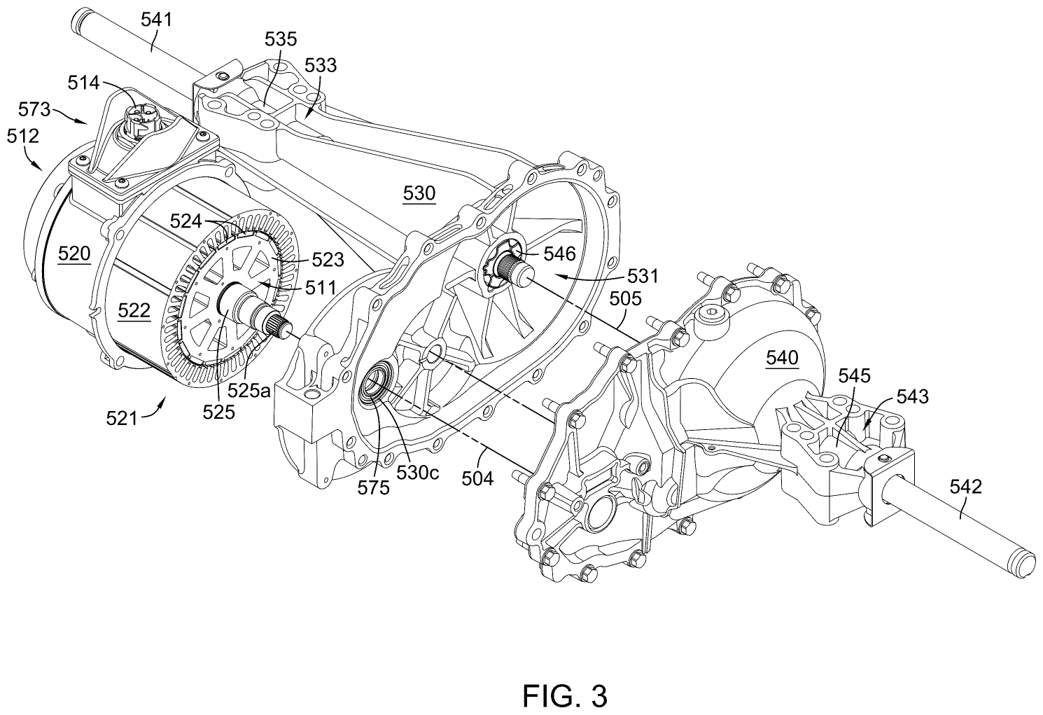

As shown most clearly in FIGS. 2 and 3, electric motor 521 is a brushless motor that is partially disposed in motor end cap 520. To improve clarity of illustration, electrical wiring (including motor windings) is not shown. Electric motor 521 comprises a motor stator 522 and a motor rotor assembly 511 that includes a motor rotor 523 and magnets 524. As shown in FIG. 1, motor stator housing 517 may be a finned aluminum extrusion cut to a length dependent upon the number of laminations used to form motor stator 522. The fins improve heat dissipation and provide stiffness. Motor output shaft 525 (also referred to as “output shaft”) extends along axis of rotation 504, through electric motor 521, and to reduction gears in reduction gear chamber 531. Motor output shaft 525 of electric motor assembly 570 is supported by a pair of bearings 576, one of which is installed in through-opening 530c of main housing 530 as shown in FIG. 2 and the other of which (not shown) is installed in motor end cap 520. Splines (not shown) are provided on motor output shaft 525 for engaging motor rotor 523 of motor rotor assembly 511. A Hall effect board (not shown) may be attached inside motor end cap 520 adjacent to motor rotor assembly 511.

Electric brake assembly 512 is attached externally to the distal side of motor end cap 520 and is engaged to splines (not shown) formed on the distal end of motor output shaft 525. An electric brake assembly, such as that depicted herein, is illustrated and described in more detail in commonly-owned U.S. patent application Ser. No. 17/658,171, which is incorporated herein by reference in its entirety.

Main housing 530 and side housing 540 are joined to form reduction gear chamber 531 (also referred to as “second chamber”) in which a reduction gear train 550 is housed. That is, main housing 530 partially defines reduction gear chamber 531, and side housing 540 partially defines reduction gear chamber 531. As shown in FIG. 3, motor output shaft seal 575 is installed in through-opening 530c (adjacent to motor output shaft bearing 576 shown in FIG. 2) to isolate electric motor 521 from reduction gear train 550, which may run in oil. That is, oil may be housed in reduction gear chamber 531 for reduction gear train 550. Splines 525a are provided on an end of motor output shaft 525 to engage a pinion gear 547 that drives reduction gear train 550 (also referred to as “reduction gears”).

Axle horn 535 (also referred to as “first axle horn”) is connected to (e.g., integrally formed on) main housing 530 and defines chamber 533 (also referred to as “first chamber” and “first axle horn chamber”). In the illustrated example, axle horn 535 is integrally and monolithically formed with main housing 530. Axle 541 (also referred to as “output axle” and “first output axle”) extends through axle horn 535 along axis of rotation 505 to engage an output gear of differential gear set 560 associated with reduction gear train 550. Axle 541 may be fully disposed within a volume of oil, partially disposed within a volume of oil, or at least exposed to splash from a volume of oil, during operation of electric transaxle 510. Axle horn 535 supports axle 541 extending therethrough. Similarly, as shown in FIG. 3, side housing 540 includes axle horn 545. Axle horn 545 defines chamber 543 (also referred to as “third chamber” and “second axle horn chamber”) that is fluidly connected with reduction gear chamber 531. In the illustrated example, first chamber 533, second reduction gear chamber 531, and third chamber 543 are fluidly connected via flow-through bearings 546 installed in main housing 530 and side housing 540 (i.e., located on opposite sides of differential gear set 560) such that oil is present in chambers 533 and 543 when oil is present in reduction gear chamber 531. Axle 542 (also referred to as “output axle” and “second output axle”) extends through axle horn 545 along axis of rotation 505 to engage an output gear of differential gear set 560 associated with reduction gear train 550. Axle 542 may be fully disposed within a volume of oil, partially disposed within a volume of oil, or at least exposed to splash from a volume of oil, during operation of electric transaxle 510. Axle horn 545 supports axle 542 extending therethrough. Notably, the output gear of differential gear set 560 engaged by axle 541 may be different that the output gear of differential gear set 560 engaged by axle 542, such that axle 541 and axle 542 may operate independently of one another and rotate at separate rates.

In the illustrated example, reduction gear train 550 is a two-stage reduction gear train. The differential gear set 560 (with differential lock option, not shown) is supported partially by a final output gear 555 of reduction gear train 550 and partially by splined ends of axles 541, 542. Both axles 541, 542 extend along axis of rotation 505, and motor output shaft 525 extends along axis of rotation 504. In the illustrated example, axis of rotation 505 is parallel to and offset from axis of rotation 504.

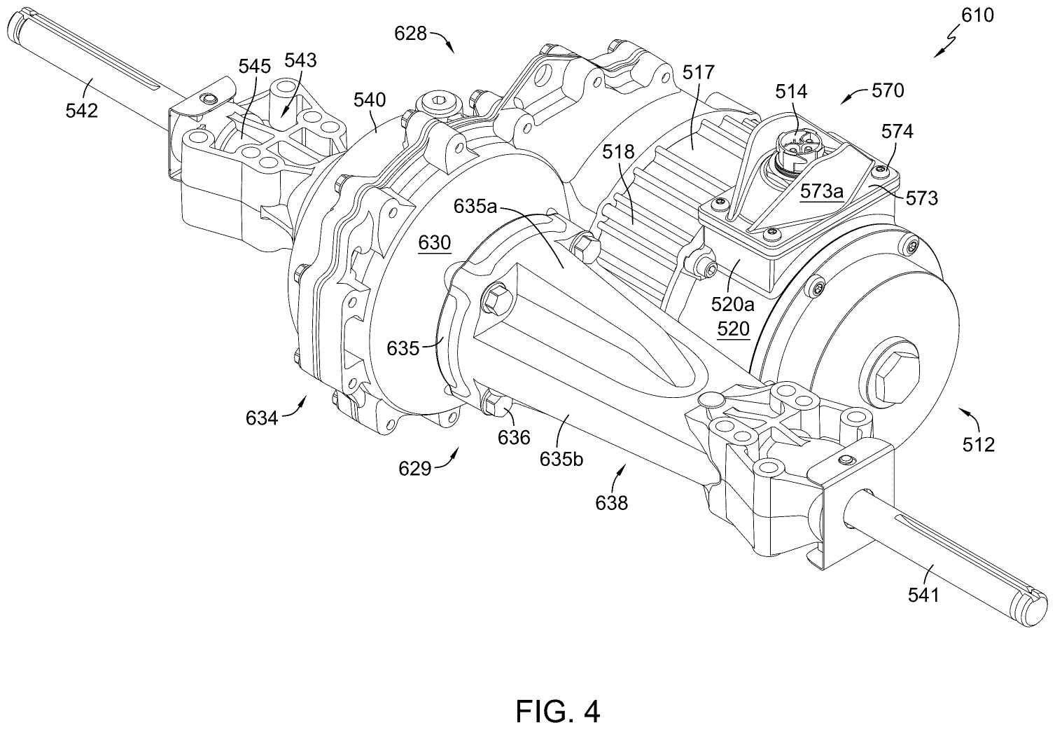

As depicted in FIGS. 4-6, another disclosed example electric transaxle 610 is similar to or the same as electric transaxle 510 in many design aspects, but includes an axle horn 635 that is lobed and bolted-on.

Similar to electric transaxle 510 of FIGS. 1-3, motor end cap 520 is attached to a main housing 630 using four fasteners 518 equidistantly spaced on bolt circle 530a such that motor end cap 520 (and electrical connector 514) can be rotationally oriented about axis of rotation 504 of motor output shaft 525 to enable mounting of electric motor assembly 570 in at least three (and possibly four, depending on mating connector used) different orientations in the illustrated example.

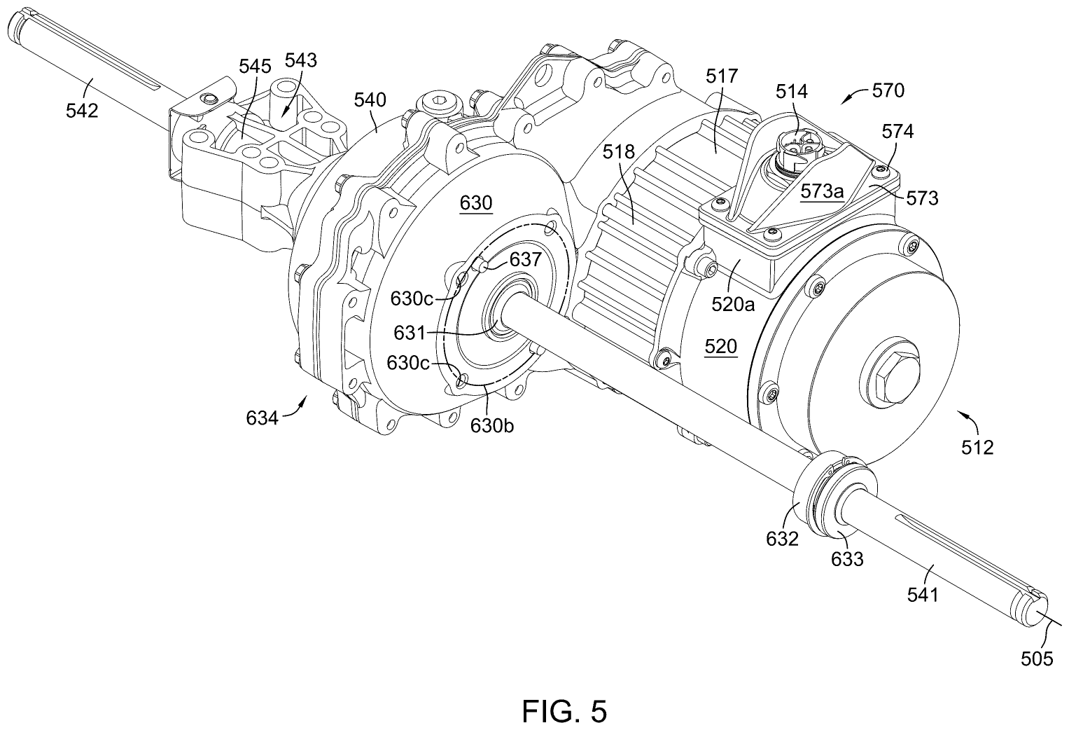

Referring to FIGS. 4 and 5, a transaxle housing assembly 628 includes a main housing assembly 629 and a side housing 540. Main housing assembly 629 includes a main housing 630 and an axle horn 635. Main housing 630 and side housing 540 are joined to form chamber 634 (also referred to as “reduction gear chamber” and “second chamber”) in which reduction gear train 550 is housed. Axle horn 635 (also referred to as “first axle horn” and “bolt-on axle horn”) is attached to main housing 630 by means of fasteners 636 (also referred to as “second plurality of fasteners” and “axle horn fasteners”). That is, axle horn 635 is separate from (FIG. 5) and connectable to (FIG. 4) main housing 630. In the illustrated example, axle horn 635 defines chamber 638 (also referred to as “first axle horn chamber”) that is separate and fluidly isolated from chamber 634. Axle 541 extends through axle horn 635 along axis of rotation 505 to engage an output gear of differential gear set 560 associated with reduction gear train 550. Axle horn 635 supports axle 541 extending therethrough.

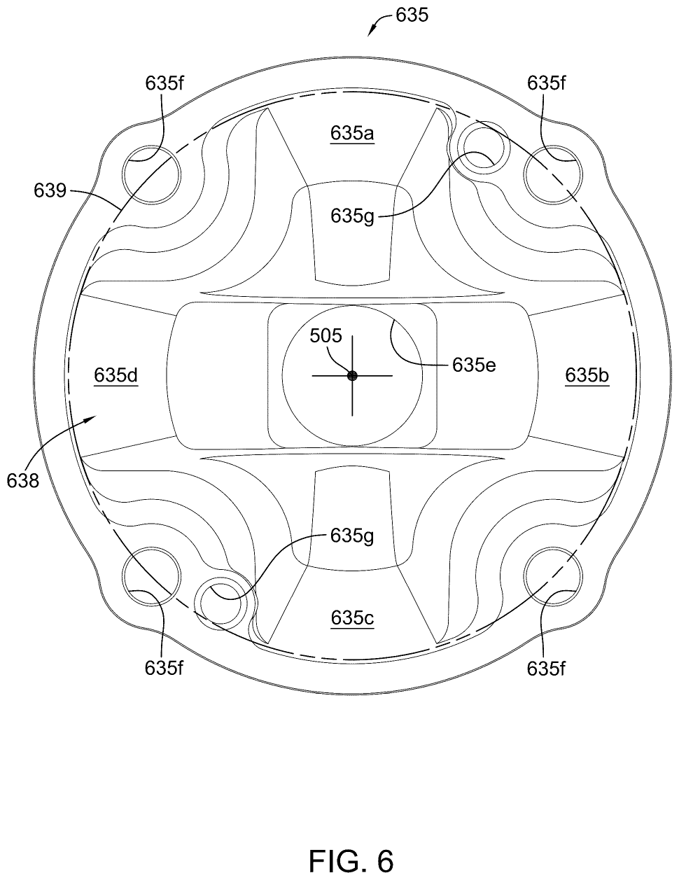

Axle horn 635 includes a plurality of lobes. In some examples, each of the lobes may be tapered, and the lobes are spaced equi-rotationally apart from each other about axis of rotation 505. For example, each tapered lobe has a curvilinear profile to reduce an amount of debris trapped by the exterior surfaces of axle horn 635. In the illustrated example, axle horn 635 includes four lobes 635a, 635b, 635c, 635d formed at right angles to one another as shown in FIG. 6. Lobes 635a, 635b, 635c, 635d are arrayed about axis of rotation 505 of axles 541, 542 in electric transaxle 610. In the illustrated example, lobes 635b, 635d are primary lobes that extend from axis of rotation 505. Lobes 635a, 635c, which are transverse to lobes 635b, 635d, are secondary, reinforcement lobes. The reinforcement lobes extend a lesser distance from main housing 630 in order to optimize material usage and achieve a balance between material cost and structural integrity.

As shown in FIG. 5, main housing 630 defines bolt holes 630c (also referred to as “threaded holes” and “second plurality of threaded holes”). Bolt holes 630c are equidistantly spaced apart and arranged on a bolt circle 630b (also referred to as “second bolt circle”) about axis of rotation 505 to form a regular polygon. Similarly, as shown in FIG. 6, axle horn 635 defines through-holes 635f (also referred to as “second plurality of through-holes”) that are equidistantly spaced apart and arranged on bolt circle 639 (also referred to as “second bolt circle”) about axis of rotation 505 to form the same regular polygon. These two regular polygons are both centered about the axis of rotation 505. Each fastener 636 extends through a respective through-hole 635f and engages a respective bolt hole 630c to attach first axle horn 635 to main housing 630. Additionally, axle horn 635 defines an axle opening 635e and locator bores 635g for locator pins 637.

In the illustrated example, there are four through-holes 635f and two locator bores 635g. Through-holes 635f are offset 45 degrees from the centerline of each lobe 635a, 635b, 635c, 635d so that each fastener 636 (e.g., threaded fastener) is located equidistantly from the centerlines of each adjacent pair of lobes. The locator pins 637, shown installed in main housing 630 in FIG. 5, are used as assembly aids.

In some examples, no oil or other liquid lubricant is housed in chamber 638 of axle horn 635. That is, chamber 634 houses liquid lubricant for reduction gears, and chamber 638 may house a volume of air and no liquid lubricant. In other examples, a volume of oil may be housed in chamber 638. As shown in FIG. 5, axle 541 extends from main housing 630 and through an axle shaft oil seal 631 and a sealed bearing 632. Axle shaft oil seal 631 is installed in main housing 630. In some examples, an environmental seal 633 is installed adjacent to sealed bearing 632 for additional environmental protection for sealed bearing 632. Further, in some examples, axle horn 635 is sealed to main housing 630 at bolt circle 630b to further reduce or eliminate oil leaks (or is sealed to main housing 630 as needed when chamber 638 houses a volume of oil). When not sealed at bolt circle 630b, additional savings of material, cost and weight can be realized.

Exemplary embodiments in accordance with the teachings herein are disclosed below.

Embodiment 1. An electric transaxle includes a transaxle housing assembly including a main housing and a first axle horn attached to the main housing to form a first chamber and supporting a first output axle disposed therein. The electric transaxle includes a side housing that is joined to the main housing to form a second chamber and includes a second axle horn supporting a second output axle disposed therein. The electric transaxle includes an electric motor assembly attached to the main housing by means of fasteners arrayed on a first bolt circle and including an output shaft having a first axis of rotation. The output shaft extends into the main housing. The first output axle and the second output axle share a second axis of rotation offset from and parallel to the first axis of rotation and rotate independently about the second axis of rotation. The electric motor assembly is configured to be attached to the main housing in multiple orientations by rotationally orienting the electric motor assembly about the first axis of rotation.

Embodiment 2. The electric transaxle of embodiment 1, wherein the first axle horn is joined to the main housing by fasteners positioned on a second bolt circle.

Embodiment 3. The electric transaxle of embodiment 2, wherein the fasteners are equidistantly spaced on the second bolt circle.

Embodiment 4. The electric transaxle of any of embodiments 1-3, wherein the first axle horn includes four tapered lobes formed at right angles to one another and arrayed about the second axis of rotation.

Embodiment 5. The electric transaxle of embodiment 4, wherein two of the four tapered lobes are positioned 180 degrees from one another and extend a first distance from the second bolt circle. The other two of the four tapered lobes are positioned 180 degrees from one another and extend a lesser second distance from the second bolt circle.

Embodiment 6. The electric transaxle of any of embodiments 1-5, wherein the second chamber houses a volume of oil and reduction gears.

Embodiment 7. The electric transaxle of embodiment 6, wherein the second output axle is at least exposed to the volume of oil.

Embodiment 8. The electric transaxle of any of embodiments 1-7, wherein the first output axle is disposed within a volume of air in the first chamber.

Embodiment 9. The electric transaxle of any of embodiments 1-8, wherein the first chamber houses no oil.

Embodiment 10. The electric transaxle of any of embodiments 1-8, wherein the first axle horn houses no oil or other liquid lubricant.

Embodiment 11. An electric transaxle includes a main housing at least partially defining a reduction gear chamber in which reduction gears are housed. The main housing further defines a first plurality of threaded holes equidistantly spaced apart and arranged to form a first regular polygon shape. The electric transaxle includes a first axle horn connected to the main housing. The first axle horn is configured to support a first output axle extending therethrough along an axle axis of rotation and to the reduction gears. The electric transaxle includes an electric motor assembly that includes an electrical connector and is attached to the main housing next to the first axle horn to form a compact arrangement. The electric motor assembly defines a first plurality of through-holes equidistantly spaced apart and arranged about a motor axis of rotation to form the first regular polygon shape. The electric transaxle includes a first plurality of fasteners, each of which extends through a respective one of the first plurality of through-holes and is engages a respective one of the first plurality of threaded holes, to attach the electric motor assembly to the main housing. The first plurality of through-holes and the first plurality of threaded holes are arranged in the first regular polygon shape to enable attachment of the electric motor assembly to the main housing in multiple orientations to position the electrical connector away from the first axle horn in various installed orientations of the electric transaxle.

Embodiment 12. The electric transaxle of embodiment 11, wherein the motor axis of rotation is offset from and parallel to the axle axis of rotation.

Embodiment 13. The electric transaxle of embodiment 11 or 12, wherein the electric motor assembly further includes a motor end cap that defines the first plurality of through-holes.

Embodiment 14. The electric transaxle of embodiment 13, wherein the electric motor assembly further includes an electrical compartment cover attached to the motor end cap and to which the electrical connector is attached.

Embodiment 15. The electric transaxle of any of embodiments 11-14, wherein the electric motor assembly further includes an output shaft extending along the motor axis of rotation and to the reduction gears.

Embodiment 16. The electric transaxle of any of embodiments 11-15, wherein each of the first plurality of through-holes and the first plurality of threaded holes includes four holes to enable four orientations of the electric motor assembly with respect to the main housing.

Embodiment 17. The electric transaxle of embodiment 16, wherein three of the four orientations are configured to position the electrical connector away from the first axle horn.

Embodiment 18. The electric transaxle of any of embodiments 11-17, wherein the first axle horn is integrally and monolithically formed with the main housing.

Embodiment 19. The electric transaxle of any of embodiments 11-18, wherein the first axle horn defines a first axle horn chamber that is fluidly connected to the reduction gear chamber.

Embodiment 20. The electric transaxle of embodiment 19, wherein oil is housed in the first axle horn chamber.

Embodiment 21. The electric transaxle of any of embodiments 11-17, further including a second plurality of fasteners to attach the first axle horn to the main housing.

Embodiment 22. The electric transaxle of embodiment 21, wherein the main housing further defines a second plurality of threaded holes equidistantly spaced apart and arranged to form a second regular polygon shape, the first axle horn defines a second plurality of through-holes equidistantly spaced apart and arranged about the axle axis of rotation to form the second regular polygon shape, and each of the second plurality of fasteners extends through a respective one of the second plurality of through-holes and engages a respective one of the second plurality of threaded holes to attach the first axle horn to the main housing.

Embodiment 23. The electric transaxle of any of embodiments 11-17 and 21-22, wherein the first axle horn includes a plurality of tapered lobes that are spaced equi-rotationally apart from each other about the axle axis of rotation.

Embodiment 24. The electric transaxle of embodiment 23, wherein the plurality of tapered lobes consists of four tapered lobes. Two opposing lobes of the four tapered lobes are primary lobes that extend from the axle axis of rotation, and the other two opposing lobes of the four tapered lobes are secondary lobes that are transverse to the primary lobes.

Embodiment 25. The electric transaxle of embodiment 23 or 24, wherein each of the plurality of tapered lobes has a curvilinear profile to reduce an amount of debris trapped by exterior surfaces of the first axle horn.

Embodiment 26. The electric transaxle of any of embodiments 11-17 and 21-25, wherein the first axle horn defines a first axle horn chamber that is separate and fluidly isolated from the reduction gear chamber.

Embodiment 27. The electric transaxle of embodiment 26, wherein the reduction gear chamber is configured to house liquid lubricant for the reduction gears. The first axle horn chamber is configured to house a volume of air and no liquid lubricant.

Embodiment 28. The electric transaxle of embodiment 26 or 27, further including an axle shaft oil seal installed in the main housing and further including a sealed bearing. The first output axle extends from the main housing and through the axle shaft oil seal and the sealed bearing.

Embodiment 29. The electric transaxle of embodiment 28, further including an environmental seal installed adjacent to the sealed bearing to provide environmental protection to the sealed bearing.

Embodiment 30. The electric transaxle of any of embodiments 11-29, further including a side housing joined to the main housing to form the reduction gear chamber with the main housing.

Embodiment 31. The electric transaxle of embodiment 30, wherein the side housing includes a second axle horn configured to support a second output axle extending therethrough along the axle axis of rotation and to the reduction gears.

Embodiment 32. The electric transaxle of embodiment 31, wherein the second output axle is configured to rotate independently of the first output axle about the axle axis of rotation.

Embodiment 33. The electric transaxle of any of embodiments 11-32, wherein the electrical connector is connected to a vehicle control system by a flexible electrical cable providing three-phase power to a CAN bus connector for power and communication inputs.

Embodiment 34. An electric transaxle includes a main housing at least partially defining a reduction gear chamber in which reduction gears are housed. The electric transaxle includes a first axle horn attached to the main housing. The first axle horn is configured to support a first output axle extending therethrough along an axle axis of rotation and to the reduction gears. The electric transaxle includes an electric motor assembly attached to the main housing next to the first axle horn to form a compact arrangement. The electric motor assembly is configured to be attached to the main housing in multiple rotational orientations about a motor axis of rotation.

Embodiment 35. The electric transaxle of embodiment 34, wherein the motor axis of rotation is offset from and parallel to the axle axis of rotation.

Embodiment 36. The electric transaxle of embodiment 34 or 35, wherein the electric motor assembly includes an electrical connector.

Embodiment 37. The electric transaxle of embodiment 36, wherein the main housing further defines a first plurality of threaded holes equidistantly spaced apart and arranged to form a first regular polygon shape.

Embodiment 38. The electric transaxle of embodiment 37, wherein the electric motor assembly defines a first plurality of through-holes equidistantly spaced apart and arranged about the motor axis of rotation to form the first regular polygon shape.

Embodiment 39. The electric transaxle of embodiment 38, further including a first plurality of fasteners, each of which extends through a respective one of the first plurality of through-holes and engages a respective one of the first plurality of threaded holes to attach the electric motor assembly to the main housing.

Embodiment 40. The electric transaxle of embodiment 39, wherein the electric motor assembly is configured to be attached to the main housing in the multiple rotational orientations to position the electrical connector away from the first axle horn in various installed orientations of the electric transaxle.

Embodiment 41. The electric transaxle of any of embodiments 38-40, wherein each of the first plurality of through-holes and the first plurality of threaded holes includes four holes to enable four orientations of the electric motor assembly with respect to the main housing.

Embodiment 42. The electric transaxle of embodiments 41, wherein three of the four orientations are configured to position the electrical connector away from the first axle horn.

Embodiment 43. The electric transaxle of any of embodiments 38-42, wherein the electric motor assembly further includes a motor end cap that defines the first plurality of through-holes.

Embodiment 44. The electric transaxle of embodiment 43, wherein the electric motor assembly further includes an electrical compartment cover attached to the motor end cap and to which the electrical connector is attached.

Embodiment 45. The electric transaxle of any of embodiments 34-44, wherein the electric motor assembly includes an output shaft extending along the motor axis of rotation and to the reduction gears.

Embodiment 46. The electric transaxle of any of embodiments 34-45, wherein the first axle horn is integrally and monolithically formed with the main housing.

Embodiment 47. The electric transaxle of any of embodiments 34-46, wherein the first axle horn defines a first axle horn chamber that is fluidly connected to the reduction gear chamber.

Embodiment 48. The electric transaxle of embodiment 47, wherein oil is housed in the first axle horn chamber.

Embodiment 49. The electric transaxle of any of embodiments 34-45, further including a second plurality of fasteners to attach the first axle horn to the main housing.

Embodiment 50. The electric transaxle of embodiment 49, wherein the main housing further defines a second plurality of threaded holes equidistantly spaced apart and arranged to form a second regular polygon shape, the first axle horn defines a second plurality of through-holes equidistantly spaced apart and arranged about the axle axis of rotation to form the second regular polygon shape, and each of the second plurality of fasteners extends through a respective one of the second plurality of through-holes and engages a respective one of the second plurality of threaded holes to attach the first axle horn to the main housing.

Embodiment 51. The electric transaxle of any of embodiments 34-45 and 49-50, wherein the first axle horn includes a plurality of tapered lobes that are spaced equi-rotationally apart from each other about the axle axis of rotation.

Embodiment 52. The electric transaxle of embodiment 51, wherein the plurality of tapered lobes consists of four tapered lobes. Two opposing lobes of the four tapered lobes are primary lobes that extend from the axle axis of rotation and the other two opposing lobes of the four tapered lobes are secondary lobes that are transverse to the primary lobes.

Embodiment 53. The electric transaxle of embodiment 51 or 52, wherein each of the plurality of tapered lobes has a curvilinear profile to reduce an amount of debris trapped by exterior surfaces of the first axle horn.

Embodiment 54. The electric transaxle of any of embodiments 34-45 and 49-53, wherein the first axle horn defines a first axle horn chamber that is separate and fluidly isolated from the reduction gear chamber.

Embodiment 55. The electric transaxle of embodiment 54, wherein the reduction gear chamber is configured to house liquid lubricant for the reduction gears. The first axle horn chamber is configured to house a volume of air and no liquid lubricant.

Embodiment 56. The electric transaxle of embodiment 54 or 55, further including an axle shaft oil seal installed in the main housing and further including a sealed bearing. The first output axle extends from the main housing and through the axle shaft oil seal and the sealed bearing.

Embodiment 57. The electric transaxle of embodiment 56, further including an environmental seal installed adjacent to the sealed bearing to provide environmental protection to the sealed bearing.

Embodiment 58. The electric transaxle of any of embodiments 34-57, further including a side housing joined to the main housing to form the reduction gear chamber with the main housing.

Embodiment 59. The electric transaxle of embodiment 58, wherein the side housing includes a second axle horn configured to support a second output axle extending therethrough along the axle axis of rotation and to the reduction gears.

Embodiment 60. The electric transaxle of embodiment 59, wherein the second output axle is configured to rotate independently of the first output axle about the axle axis of rotation.

Embodiment 61. The electrical transaxle of any of embodiments 34-60, wherein the reduction gear chamber further comprises a differential gear set.

Embodiment 62. The electrical transaxle of any of embodiments 34-58, further comprising a second output axle, and wherein each of the first output axle and the second output axle are connected to a different output gear of a differential gear set housed within the reduction gear chamber.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any equivalent thereof.

What is claimed is:

1. An electric transaxle, comprising:
a main housing at least partially defining a reduction gear chamber in which reduction gears are housed, wherein the main housing further defines a first plurality of threaded holes equidistantly spaced apart and arranged to form a first regular polygon shape;
a first axle horn attached to the main housing, wherein the first axle horn is configured to support a first output axle extending therethrough along an axle axis of rotation and to the reduction gears;
an electric motor assembly comprising an electrical connector, the electric motor assembly attached to the main housing next to the first axle horn, wherein the electric motor assembly defines a first plurality of through-holes equidistantly spaced apart and arranged about a motor axis of rotation to form the first regular polygon shape; and
a first plurality of fasteners, each of which extends through a respective one of the first plurality of through-holes and engages a respective one of the first plurality of threaded holes to enable attachment of the electric motor assembly to the main housing,
wherein the first plurality of through-holes and the first plurality of threaded holes are arranged in the first regular polygon shape to enable the electric motor assembly to be attached to the main housing in multiple orientations to position the electrical connector away from the first axle horn in various installed orientations of the electric transaxle.

2. The electric transaxle of claim 1, wherein the motor axis of rotation is offset from and parallel to the axle axis of rotation.

3. The electric transaxle of claim 1, wherein the electric motor assembly further comprises a motor end cap that defines the first plurality of through-holes, and wherein the electric motor assembly further comprises an electrical compartment cover attached to the motor end cap and to which the electrical connector is attached.

4. The electric transaxle of claim 1, wherein the electric motor assembly further comprises an output shaft extending along the motor axis of rotation and to the reduction gears.

5. The electric transaxle of claim 1, wherein each of the first plurality of through-holes and the first plurality of threaded holes includes four holes to enable four orientations of the electric motor assembly with respect to the main housing, and wherein three of the four orientations are configured to position the electrical connector away from the first axle horn.

6. The electric transaxle of claim 1, further comprising a second plurality of fasteners to attach the first axle horn to the main housing.

7. The electric transaxle of claim 6, wherein:
the main housing further defines a second plurality of threaded holes equidistantly spaced apart and arranged to form a second regular polygon shape;
the first axle horn defines a second plurality of through-holes equidistantly spaced apart and arranged about the axle axis of rotation to form the second regular polygon shape; and
each of the second plurality of fasteners extends through a respective one of the second plurality of through-holes and engages a respective one of the second plurality of threaded holes to attach the first axle horn to the main housing.

8. The electric transaxle of claim 1, wherein the first axle horn comprises a plurality of tapered lobes that are spaced equi-rotationally apart from each other about the axle axis of rotation.

9. The electric transaxle of claim 8, wherein the plurality of tapered lobes consists of four tapered lobes, wherein two opposing lobes of the four tapered lobes are primary lobes that extend from the axle axis of rotation, and wherein the other two opposing lobes of the four tapered lobes are secondary lobes that are transverse to the primary lobes.

10. The electric transaxle of claim 8, wherein each of the plurality of tapered lobes has a curvilinear profile to reduce an amount of debris trapped by exterior surfaces of the first axle horn.

11. The electric transaxle of claim 1, wherein the first axle horn defines a first axle horn chamber that is separate and fluidly isolated from the reduction gear chamber, wherein the reduction gear chamber is configured to house liquid lubricant for the reduction gears, and wherein the first axle horn chamber is configured to house a volume of air and no liquid lubricant.

12. The electric transaxle of claim 11, further comprising an axle shaft oil seal installed in the main housing and further including a sealed bearing, wherein the first output axle extends from the main housing and through the axle shaft oil seal and the sealed bearing.

13. The electric transaxle of claim 12, further comprising an environmental seal installed adjacent to the sealed bearing to provide environmental protection to the sealed bearing.

14. The electric transaxle of claim 1, further comprising a side housing joined to the main housing to form the reduction gear chamber with the main housing.

15. The electric transaxle of claim 14, wherein the side housing comprises a second axle horn configured to support a second output axle extending therethrough along the axle axis of rotation and to the reduction gears, and wherein the second output axle is configured to rotate independently of the first output axle about the axle axis of rotation.

16. An electric transaxle, comprising:
a transaxle housing assembly comprising:
a main housing; and
a first axle horn attached to the main housing to form a first chamber and supporting a first output axle disposed therein;
a side housing that is joined to the main housing to form a second chamber and includes a second axle horn supporting a second output axle disposed therein;
an electric motor assembly attached to the main housing by means of fasteners arrayed on a first bolt circle and comprising an output shaft having a first axis of rotation, wherein the output shaft extends into the main housing, and
wherein the first output axle and the second output axle share a second axis of rotation offset from and parallel to the first axis of rotation and rotate independently about the second axis of rotation, and
wherein the electric motor assembly is configured to be attached to the main housing in multiple orientations by rotationally orienting the electric motor assembly about the first axis of rotation.

17. The electric transaxle of claim 16, wherein the first axle horn is joined to the main housing by fasteners positioned on a second bolt circle, and wherein the fasteners are equidistantly spaced on the second bolt circle.

18. The electric transaxle of claim 16, wherein the first axle horn includes four tapered lobes formed at right angles to one another and arrayed about the second axis of rotation.

19. The electric transaxle of claim 16, wherein the first chamber houses no oil.

20. The electric transaxle of claim 19, wherein the second chamber houses a volume of oil and reduction gears.
